(19) United States
(12) Patent Application Publication
(10) Pub. No.: US 2003/0233320 A1
(43) Pub. Date: Dec. 18, 2003

(54) Unified electronic transaction fulfillment

(76) Inventor: Robert W. Connor JR., Wyndmoor, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/461,659

(22) Filed: Jun. 13, 2003

Related U.S. Application Data
(60) Provisional application No. 60/388,257, filed on Jun. 13, 2002.

(51) Int. Cl. G06F 17/60

(52) U.S. Cl. 705/39; 705/40

(57) ABSTRACT

A variety of electronic payment solutions and user affinity system and methods are provided. The electronic payment solutions allow participating customers to exploit legacy transaction systems and provide a basis to electronically establish user affinities that may be employed as part of one or more targeted marketing efforts. In an illustrative implementation, a participating user is issued a UPC bar code ID that is storable on a variety of media ranging from print medium to electronic media (FOB wand, stored in a cell phone, SIM Card, or other mobile computing device). The UPC bar code ID may be linked to the participating user's bank and/or credit card accounts. In operation, when the participating user purchases a product and/or service, the participating user offers the UPC bar code ID to the retailer to pay for the product and/or service. The retailer processes the UPC bar code ID using legacy UPC bar code ID transaction equipment to indicate the appropriate charges against the participating users' account(s).

### CROSS-REFERENCE TO RELATED APPLICATIONS

This application claims benefit of Provisional Application No. 60/388,257 filed Jun. 13, 2002, entitled “Unified Electronic Transaction Fulfillment” the entirety of which is incorporated herein by reference.

### FIELD OF THE INVENTION

The present invention relates to the field of electronic payment systems and methods and systems and methods to electronically establish user affinities, and more particularly, to automated transaction solutions that exploit existing legacy electronic transaction systems and methods and that may be used to electronically establish user affinities.

### BACKGROUND OF THE INVENTION

Advances in communications and data storage technologies have had an impact on the method and manner of transactions across the board. It is hard to imagine not being able to go to a retail store or a services center and not be able to pull out a credit card or debit card to electronically pay for a desired product and/or service. Electronic payment systems and methods have established themselves as being reliable, secure, and efficient in fulfilling transactions. As such, they have become ingrained in our daily purchasing and transaction practices. However, with technology advances, there is a growing need among consumers for even more efficiency and convenience.

Consumers today are pushing for technological advances and innovations that would allow for a unified transaction system wherein a consumer can purchase products and services across all product and services providers using a single payment solution. This need is apparent as consumers are currently relegated to carrying various payment solutions to accommodate the disparate transaction systems supported by the various retailers. For example, a consumer may have to carry pocket change to pay a parking meter, cash to pay for a soda at a soda machine, and a credit/debit card to pay for a new shirt. A more comprehensive payment solution would allow consumers the ability to transact various purchases with various sources using a unified (or single) payment solution.

With a unified transaction system (solution), a slew of innovative products and services may be leveraged to consumers. For example, if a consumer is given a payment media that is accepted for any transaction requiring a payment, the payment media may inturn act as a customer identifier so that when the consumer is checking out, targeted coupons may be delivered to the consumer. As such, the unified transaction system provides a basis to establish electronically consumer affinities. Another application that might be considered is using the payment media as a storage device to store data about a product to be purchased at a later date and then using the stored data to automatically purchase the desired product and/or service at a subsequent time.

From the foregoing it is appreciated there exists a need for a system and methods that offer a unified transaction system that provides electronic payment solutions as well as other value added transaction features.

### SUMMARY OF THE ILLUSTRATED EMBODIMENTS OF THE INVENTION

Electronic payment solutions and associated value added services are provided. In an illustrative implementation, an electronic media capable of cooperating with legacy transaction systems is provided to consumers. In an illustrative implementation, the legacy system friendly electronic media interacts with a receiver to communicate payment, consumer, or other pertinent information. The receiver cooperates with a computing application operating in a computing environment that processes the payment, consumer, and other pertinent information to fulfill transactions.

In a specific implementation, consumers are offered unique UPC bar codes storable in various media ranging from printed cards to FOB wands to RKE devices to wristwatches to mobile computing devices such as pagers, mobile telephones, mobile PDAs, to lighters, and eyeware, jewelry, or currency (e.g. machine readable ink), etc. For example, the unique UPC code may comprise the UPC bar code found on a driver's license. Moreover, the unique UPC bar code may comprise UPC codes having various shapes and sizes.

In operation, the unique UPC bar code is associated with payment account information or other consumer information. In operation, retailers and service providers, equipped with legacy UPC bar code scanners can accept the unique UPC bard codes as a form of payment. In addition, the unique UPC bar codes can act as consumer identifiers from which consumer behavior may be tracked and wherein products/services affinities may be determined.

In an embodiment described here electronic media are used as storage devices to store data about a desired product or service to be used in the future to fulfill one or more transactions. For example, the electronic media may have the capability to store 10-15 seconds of a song playing on a radio. This information may then be uploaded to a cooperating computing application operating in a computing environment (e.g. a networked computing environment) where it is processed and used to help the consumer to find, download, and/or purchase the song to be stored in specified manner associated with the consumer (e.g. an online personalized locker of products).

### BRIEF DESCRIPTION OF THE DRAWINGS

The system and methods described herein are further described with reference to the accompanying drawings in which:

FIG. 1 is a system diagram of an exemplary computing environment;

FIG. 2 is a system diagram of a an exemplary networked computing environment;

FIG. 3 a block diagram of cooperating components of a unified transaction system;

FIG. 3A is a block diagram of cooperating components of a unified transaction system having security provisions;

FIG. 4 is a block diagram of exemplary unique UPC bar codes for use in an unified transaction system;

FIG. 5 is a flow diagram of processing performed to register a user with a unified transaction system;

FIG. 6 is a flow diagram of processing performed when transacting a transaction with a unified transaction system;

FIG. 7 is a flow diagram of processing performed for customer affinity;

FIG. 8 is a flow diagram of processing performed when engaging in delayed purchasing; and

FIG. 9 is a flow diagram of processing performed when engaging in smart shelf shopping.

### DETAILED DESCRIPTION OF ILLUSTRATIVE IMPLEMENTATION

Overview:

Transaction fulfillment has offered many challenges. A recent challenge has come to the forefront and is recognized as a need by today's consumers. This challenge is to provide consumers with a unified transaction fulfillment system that offers a number of value added features including electronic payment solutions and data storage of data indicative of desired products and services that are to be transacted at a later date. Current practices offer these features as part of independent, mutually exclusive systems and methods leaving it to consumers to carry the burden of aggregating these features and integrating them in their daily routines.

With the embodiments described herein, the shortcomings of existing practices are ameliorated through the offering of a comprehensive system and methods that offer customizable, robust, and adaptable transaction fulfillment. The system contemplates the use of a unique UPC bar code identifier that is associated with at least one consumer. The UPC bar code identifier is storable in or on various media ranging from print media (e.g. card, key chain card, RKE, wristwatch, use of a driver's license UPC code, SIM card, lighter, currency, mobile device housing and/or clip, eyeware, jewelry, etc. to FOB wands to mobile computing devices (e.g. mobile telephone equipped with wireless communication protocols—BlueTooth, WiFI, RFID, etc.). In operation, the unique UPC bar code is associated to consumer information (e.g. payment information—bank account information, credit card information; consumer usage information; etc.) and can be used by the consumers with retailers and service providers on-site (or online). The unified transaction system and methods contemplate the use of various sized and shaped UPC bar codes having varying orientations as a possible identifier that this specific UPC is for use in transaction fulfillment.

Another aspect of the invention contemplates the use of the electronic media used to store the unique UPC bar code for the online service associated with the electronic media, as a storage medium to store data or relay user preferences about desired products and/or services that can be used during transactions or in subsequent transaction fulfillment. As such, the present invention provides consumers with a unified transaction fulfillment system capable of supporting a number of value-added features.

Another aspect of the invention contemplates the use of the electronic media used to store the unique UPC bar code to store information about desired products and services. In operation, the consumer would shop as they would at a retail store for goods and services. The retail store is equipped with smart shelves which communicate information about products on their shelves to various electronic media. In an illustrative implementation, a consumer will pass a smart shelf where a desired product is located. The smart shelf would communicate with the electronic media to notify the consumer that they have just passed the product. In addition to notification information, the smart shelf may also communicate additional information about the product/service and/or product/service discount information.

Illustrative Computing Environment

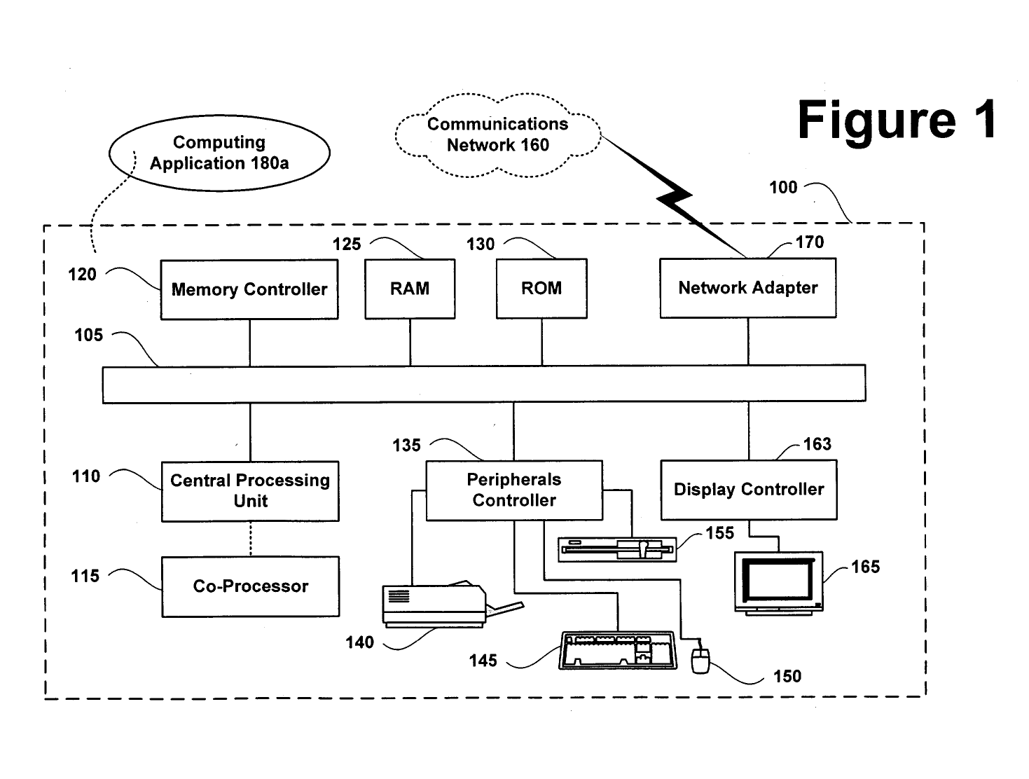

FIG. 1 depicts an exemplary computing system 100 in accordance with a preferred embodiment of the invention. Computing system 100 is capable of executing an exemplary transaction fulfillment computing application 180a that allows participating parties (e.g. customers and promoters) to perform and authenticate transactions electronically. Exemplary transaction fulfillment computing system 100 is controlled primarily by computer readable instructions, which may be in the form of software, wherever, or by whatever means such software is stored or accessed. Such software may be executed within central processing unit (CPU) 110 to cause data processing system 100 to do work. In many known workstations and personal computers central processing unit 110 is implemented by a single-chip CPU called a microprocessor. Coprocessor 115 is an optional processor, distinct from main CPU 110, that performs additional functions or assists CPU 110. One common type of coprocessor is the floating-point coprocessor, also called a numeric or math coprocessor, that is designed to perform numeric calculations faster and better than general-purpose CPU 110. Recently, however, the functions of many coprocessors have been incorporated into more powerful single-chip microprocessors.

In operation, CPU 110 fetches, decodes, and executes instructions, and transfers information to and from other resources via the computer's main data-transfer path, system bus 105. Such a system bus connects the components in computing system 100 and defines the medium for data exchange. System bus 105 typically includes data lines for sending data, address lines for sending addresses, and control lines for sending interrupts and for operating the system bus. An example of such a system bus 105 is the PCI (Peripheral Component Interconnect) bus. Some of today's advanced busses provide a function called bus arbitration that regulates access to the bus by extension cards, controllers, and CPU 110. Devices that attach to these buses and arbitrate to take over the bus are called bus masters. Bus masters support also allows multiprocessor configurations of the buses to be created by the addition of bus master adapters containing a processor and its support chips.

Memory devices coupled to system bus 105 include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 100 may contain peripherals controller 135 responsible for communicating instructions from CPU 110 to peripherals, such as, printer 140, keyboard 145, mouse 150, and disk drive 155.

Display 165, which is controlled by display controller 163, is used to display visual output generated by computing system 100. Such visual output may include text, graphics, animated graphics, and video. Display 165 may be implemented with a CRT-based video display, an LCD-based flat-panel display, gas plasma-based flat-panel display, or a touch-panel. Display controller 163 includes electronic components required to generate a video signal that is sent to display 165.

Further, computing system 100 may contain network adaptor 170 that may be used to connect computing system 100 to an external communications network 160. Communications network 160 may provide computer users with means of communicating and transferring software and information electronically. Communications network 160 also may include but is not necessarily limited to fixed-wire local area networks (LANs), wireless LANs, fixed wire wide-area-networks (WANs), wireless WANs, fixed wire extranets, wireless extranets, fixed-wire intranets, wireless intranets, fixed wire and wireless peer-to-peer networks, fixed wire and wireless virtual private networks, the Internet, and the wireless Internet. Additionally, communications network 160 may provide distributed processing, which involves several computers and the sharing of workloads or cooperative efforts in performing a task. It will be appreciated that the network connections shown are exemplary and that other means of establishing a communications link between the computers may be used.

Illustrative Computer Network Environment

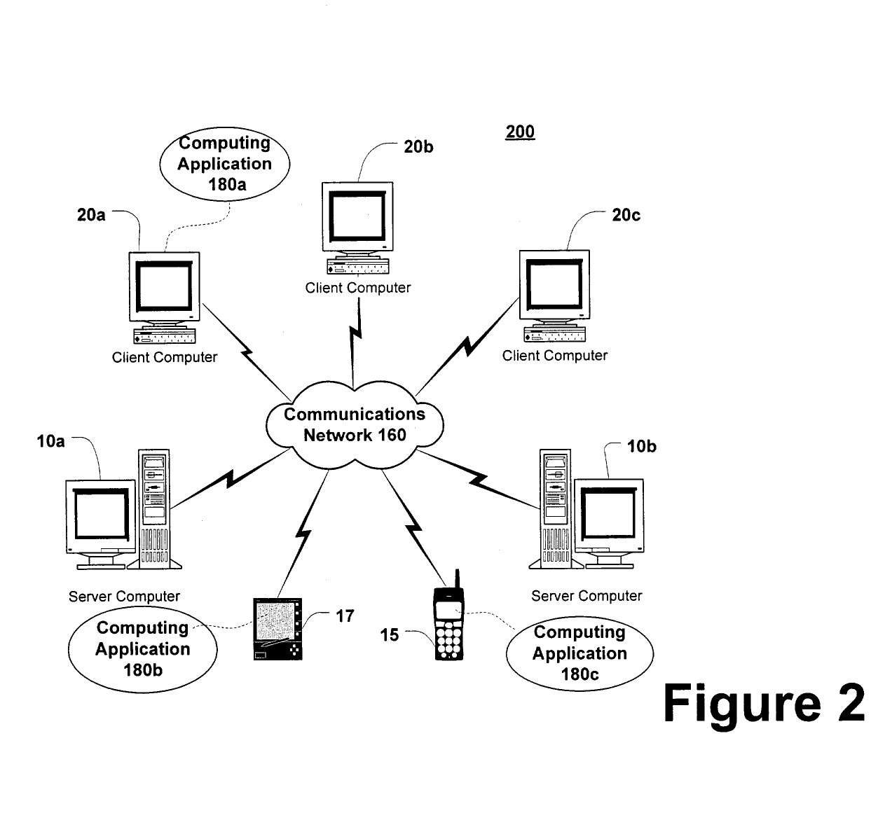

As noted above, the computer described with respect to FIG. 1 can be deployed as part of a computer network. In general, the above description applies to both server computers and client computers deployed in a network environment. FIG. 2 illustrates an exemplary network environment 200, with a server computer 10a, 10b in communication with client computers 20a, 20b, 20c via a communications network 160, in which the present invention may be employed. As shown in FIG. 2, a number of servers 10a, 10b, etc., are interconnected via a communications network 160 (which may be a LAN, WAN, intranet or the Internet) with a number of client computers 20a, 20b, 20c, or computing devices, such as, mobile phone 15 and personal digital assistant 17. In a network environment in which the communications network 160 is the Internet, for example, the servers 10 can be Web servers with which the clients 20 communicate via any of a number of known protocols, such as, hypertext transfer protocol (HTTP) or wireless application protocol (WAP), as well as other innovative communication protocols. Each client computer 20 can be equipped with computing application 180a to gain access to the servers 10. Similarly, personal digital assistant 17 can be equipped with computing application 180b and mobile phone 15 can be equipped with computing application 180c to display and receive various data.

Thus, the present invention can be utilized in a computer network environment having client computing devices for accessing and interacting with the network and a server computer for interacting with client computers. However, the systems and methods for providing adaptable rendering of data of the present invention can be implemented with a variety of network-based architectures, and thus should not be limited to the example shown. The present invention will now be described in more detail with reference to a presently illustrative implementation.

Electronic Transaction and Affinity Solutions

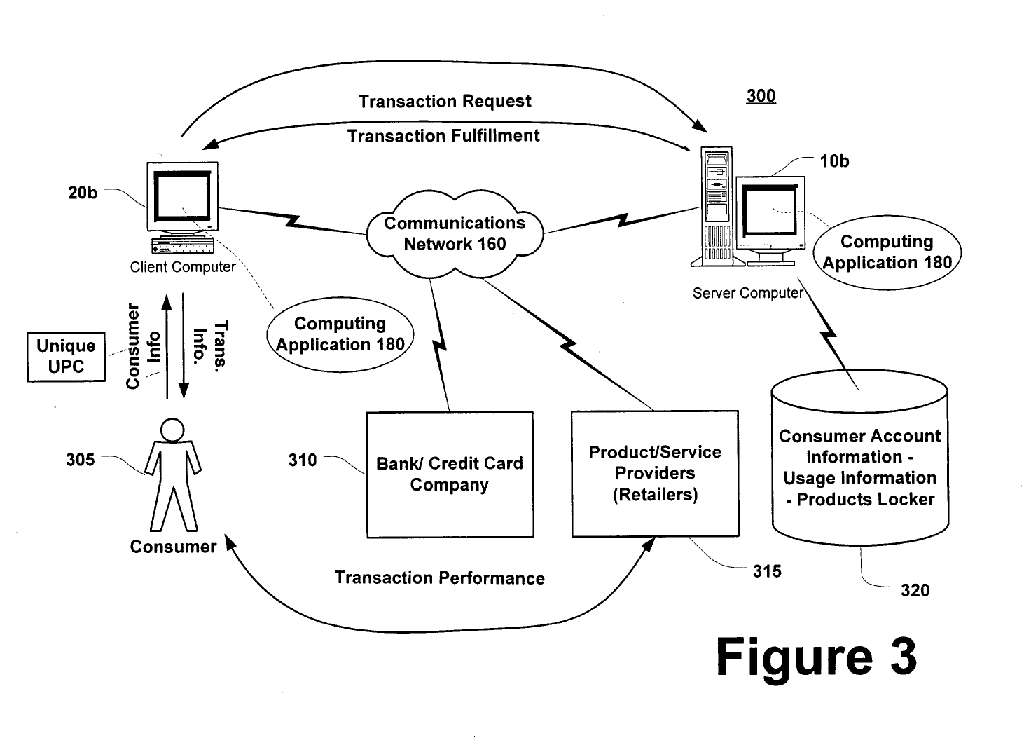

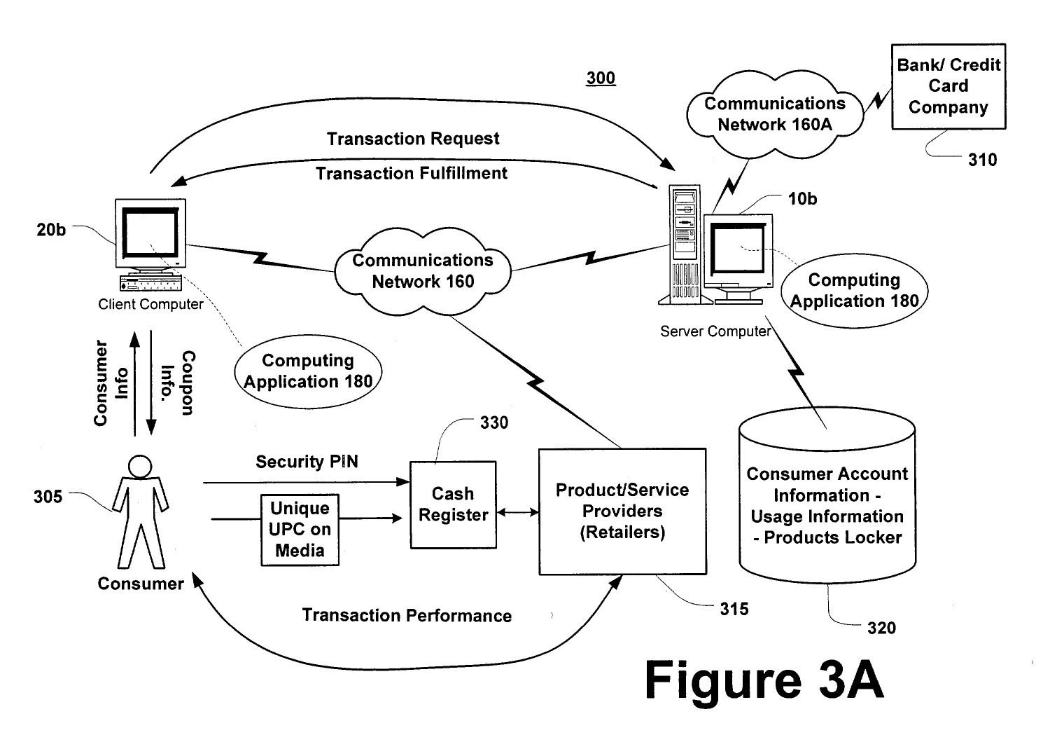

FIG. 3 shows a block diagram of exemplary components of unified electronic transaction fulfillment system 300 allowing a number of value-added features including unified electronic payment solutions, product/service affinity determination, consumer tracking, targeted marketing, and subsequent transaction fulfillment. As shown, consumer 305 interacts with exemplary computing application 180 operating partially on client computer 20b and on server computer 10b. Consumer 305 provides consumer information to computing application 180 using client computer 20b. Consumer information may include but is not limited to consumer bank/credit card information, consumer product/services preferences, consumer account information, coupon information, consumer affinity information and the like. In a contemplated implementation, computing application comprises a user interface to accept and display information regarding the customer, and their transactions. Included in such capability is a coupon storage locker. In operation, a consumer cooperates with computing application 180 to create an account. Included in the account is a coupon storage locker. When navigating through the computing application, the consumer is offered various coupons and discounts that can be stored in the storage locker for subsequent use.

The consumer information is processed by computing application 180 and provides the consumer with a unique UPC bar code that is storable by the consumer in a various media including print media, a FOB wand, a SIM card, lighter, currency (e.g. machine readable ink), eyeware, jewelry, on a mobile electronic device (or one of it's components—housing, case, etc.). In a particular implementation, the mobile electronic device is capable of supporting various wireless communication protocols including but not limited to BlueTooth, WiFi, and RFID.

In the contemplated implementation, the data storage capability may be used as an impulse capture mechanism that allows the consumers to store related data that needs to be matched and identified online through a central server. This process can involve the audio detection as described below or take the form of enabling the consumer to verbally input alpha or numeric (e.g. DTMF tones) information such as bar code numbers, UPC, assigned numbers, or keywords which later once uploaded will be used to direct them to online content related to the stored data.

In operation when a consumer wishes to realize transaction performance, the consumer interacts with the products/service providers 315 in person, or online through communications network 160. In the instance the consumer is purchasing a product or service immediately the consumer identifies the products/services to the products/services provider and prepares for checkout. At checkout, the consumer offers to the retailer the unique UPC bar code that the retailer processes (e.g. using a bar code scanner or some other receiver to cooperate with the media on which the unique UPC bar code is stored). As part of processing the retailer may interact with computing application 180 operating on server 10b using communications network 310. Computing application 180, in turn, cooperates with data store 320 to obtain consumer information (e.g. consumer account information, consumer affinity information, consumer usage information, customer coupons, etc.) that is used to realize transaction fulfillment. For example, the user account information may be used by the retailer to indicate payment for the identified products and/or services and to provide discounts to the customers through coupon redemption. In the context of coupon redemption, while the UPC is scanned a check is made against the customer account for payment information and for stored coupons. If the consumer purchased a product/service for which he/she had a stored coupon, the coupon is recognized and redeemed at the retailer point of sale. As a result the consumer is afforded immediate discounts without the need to carry bulky coupons.

In the context of payment processing, computing application 180a cooperates with the consumer's bank and/or credit card company to indicate the purchase of the identified products and/or services.

In another aspect of the invention, the consumer usage information may be used in a targeted marketing effort so that upon checkout, computing application 180 recognizing that a checkout for a particular consumer is taking place, can suggest, generate, and communicate to the retailers targeted coupons that are targeted based upon the consumer's usage information that are provided to the consumer. With this feature more relevant products and services can be offered to more relevant consumers thereby increasing the likelihood of additional purchases.

Unified electronic transaction fulfillment system 300 is capable of supporting additional features and application. For example, unified electronic transaction fulfillment system 300 is capable of performing voice to text conversion. In this instance, a consumer may store voice data indicative of a desired product/service (e.g. a song on the radio) on an electronic media. The electronic media then cooperates with exemplary computing application 180 which processes the voice data and converts the voice data into text for further processing to obtain information about the desired products/services from a database or the product/service provider themselves to realize transaction fulfillment. Another feature that may be realized is frequency long distance dialing. In this instance a portable electronic media is pre-programmed with frequency tones to engage the services of and provide billing information of the consumer to a pre-selected third party long distance provider. The consumer may use the portable electronic media on any telephone to engage the long distance provider and to place a long distance call. If the electronic media is synced online the encrypted frequency can be utilized to initiate secure online transactions which eliminate the need for the consumer to fill out online forms typically requested in the online transaction process. This feature may be linked to a request for “pin” number to insure an additional layer of security. The present invention also contemplates the use of an encrypted frequency that may be deployed in a computing environment as part of a environment security system capable of preventing access to data stored within the computing environment by anyone not possessing the electronic media containing the encrypted frequency. This “lock-up” feature could be integrated with either the operating system or cooperating computing application.

FIG. 3A shows a slightly different implementation of unified electronic transaction fulfillment system 300. The distinction being that the consumer 305 is now required to enter a unique personal identification number (PIN) when presenting their Unique UPC to product/service providers 315 to perform a coupon and/or payment transaction. In addition, server computer is now responsible for reconciling payment with the bank/credit card companies 310 over a different communications network 160A. In this context, server computer acts as the coupon and payment transaction fulfillment gateway.

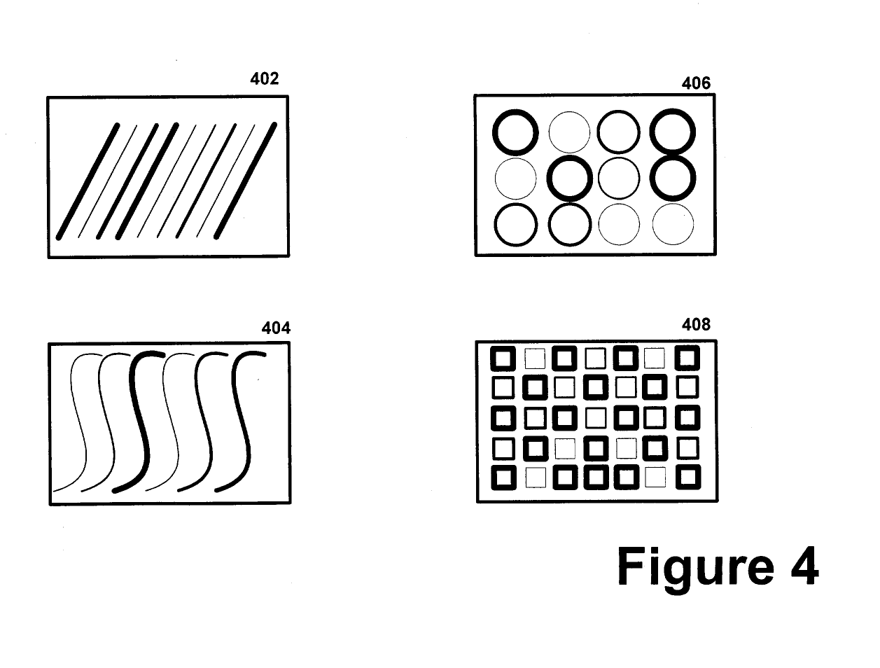

FIG. 4 shows a block diagram of exemplary universal product codes for use by the herein described systems and methods. As shown, in FIG. 4 UPC code 402 has nine slanted lines arranges such that the slanted line slants from top right to bottom left. Comparatively, UPC code 404 has six squiggly lines. The six squiggly lines are spaced horizontally and appear in a vertical arrangement. UPCs 406 and 408 are offered to demonstrate that the herein described system and methods are not limited in processing what might be considered traditional UPCs. Rather as shown by UPCs 406 and 408, non-traditional UPCs may be processed by the herein described systems and methods. Specifically, UPC 406 shows a plurality of uniform circles having various line thicknesses arranged in a symmetrical pattern. Similarly, UPC 408 shows a plurality of uniform squares having various line thicknesses also arranged in a symmetrical pattern. It is appreciated that although exemplary UPCs are provided having various configurations, shapes, components, and sizes that such UPCs are merely exemplary as the herein described systems and methods are operable on any UPC having any shape, size, component and/or configuration.

In operation, the UPCs 402, 404, 406, and 408 may be deliberately employed to indicate to the legacy systems to engage in transaction fulfillment. Stated differently, current legacy UPC processing systems are configured to process traditional UPCs (not shown) having vertical lines with varying line thickness and varying in number that are horizontally spaced from each other. The herein described systems and methods contemplate the processing of the non-traditional exemplary UPCs, 402, 404, 406, and 408 such that the legacy systems are configured to operate in a manner in which if such a non-traditional UPC is encountered then the legacy system is directed to engage in transaction fulfillment as described above.

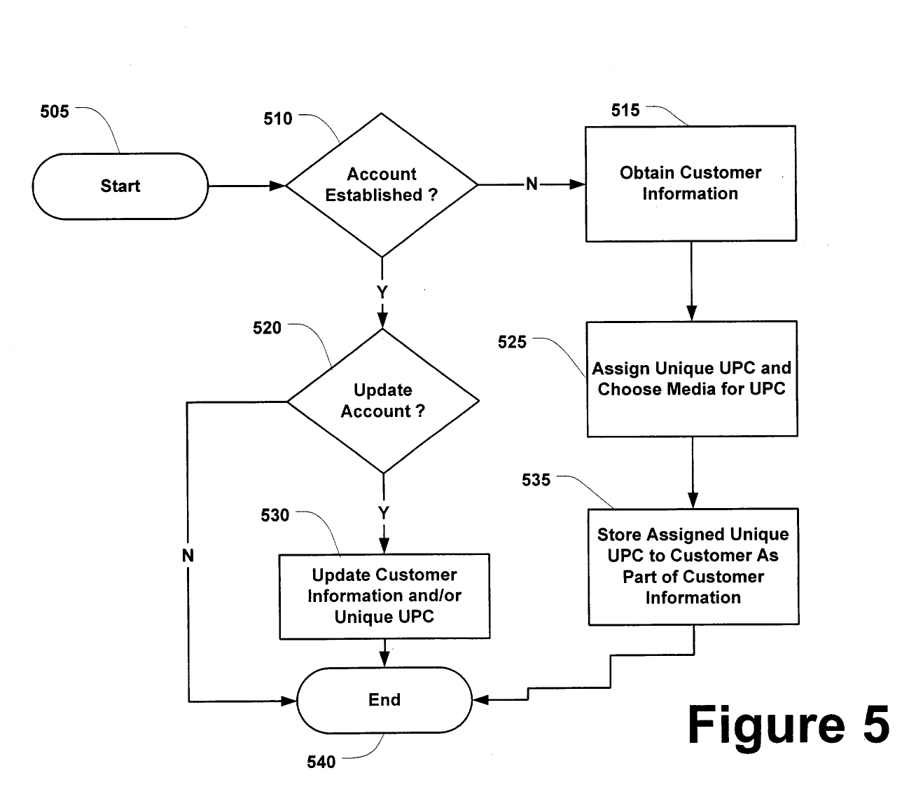

FIG. 5 is a flow chart of the processing performed to establish a user account for a customer in accordance with the herein described systems and methods. As shown, processing begins at block 505 and proceeds to block 510 where a check is performed to determine if an account has already been established. If an account has been established, processing proceeds to block 520 where a check is performed to determine if the account requires update. If no update is required at block 520, processing terminates at block 540. However, if an update is required, processing proceeds to block 530 where the customer information and/or unique UPC associated for the customer is updated. Processing then terminates at block 540.

If however, at block 510, it is determined that an account has not been established, processing proceeds to block 515 where customer information is obtained. Included in the customer information may be customer demographic information, customer banking information (or payment information), customer affinity information, and other related information required to effect the fulfillment of a transaction of goods and services by a customer for the purchase of goods and services. From there, processing proceeds to block 525, where a unique universal product code (UPC) is assigned to the customer. At block 525, the type of media on which the unique UPC code will be provided to the customer is also determined. In a contemplated implementation, the UPC media may comprise print media (business card, plastic card), electronic media (FOB wand), or electronic devices (cellular phone, wrist watch, mobile phone, PDA, mobile computer, etc). Also, in a contemplated implementation, the herein described systems and methods may offer the customer the option of using a unique UPC that may have already been assigned to the customer. For example, today, most states engage in providing a unique UPC on driver's licenses. In this context, the herein described systems and methods contemplate the use of the driver's license UPCs. Other examples of already provided unique UPCs may comprises, health insurance card UPCs, gym membership card UPCs, UPCs found on water meters and gas meters, passport UPC, and/or a car's vehicle identification number (VIN), or a combination thereof. It is appreciated that any unique UPC will work with the herein described systems and methods. From there processing proceeds to block 535 where the assigned (or provided) unique UPC is stored with the received customer information. Processing then terminates at block 540.

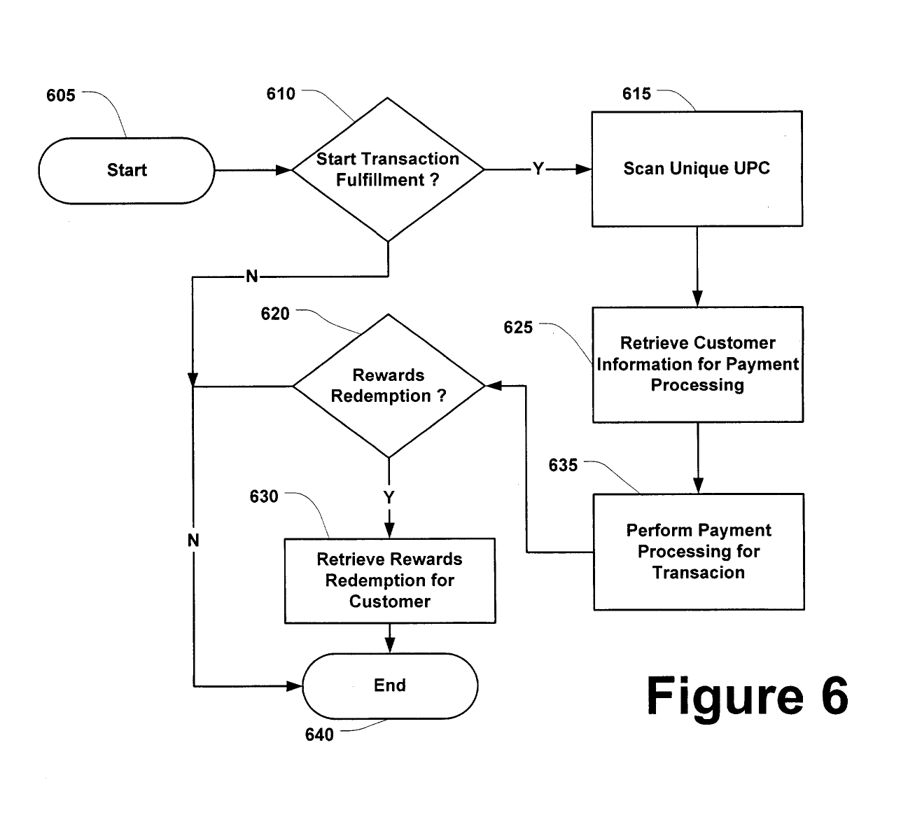

FIG. 6 shows the processing performed by the herein described systems and methods when performing transaction fulfillment. As shown, processing begins at block 605 and proceeds to block 610 where a check is performed to determine the transaction fulfillment should be performed. If it is not, processing terminates at block 640. However, if at block 610, it is determined that transaction fulfillment is to be performed, processing proceeds to block 615 where the customer's unique UPC is scanned. In operation, this scanning processing may be performed by the legacy UPC scanning systems or by an updated UPC scanning system capable of scanning the unique UPCs provided by the customer residing in the above-described various media. From block 615, processing then proceeds to block 625 where customer information for payment processing is retrieved. Payment processing is then performed at block 635.

Payment processing may encompass various methods including but not limited to credit card transactions, debit card transactions, Internet based payment transactions, and store credit payment plans. Specifically, at blocks 615 and 625, the legacy system (or updated legacy system) scans the unique UPC. Using the unique UPC, the legacy system (or updated legacy system) communicates over a communications network (not shown) to retrieve from a customer database operating on a computing environment payment and other customer information for use in payment processing.

Processing then proceeds from block 635 to block 620 where a check is performed to determine if rewards redemption is to be performed. If rewards redemption is not to be performed, processing proceeds to block 640 and terminates. However, if rewards redemption is to be performed, processing proceeds to block 630 where the relevant rewards redemption are retrieved. Part in parcel of rewards redemption processing is retrieving from the above-described customer database data representative of customer transactions which would qualify the customer for a particular reward. The herein described systems and methods contemplate the association of various rewards to customers based on a various criteria including frequency of purchases, quality of purchases, focus of purchases, and similarity of purchases. For example, a coupon reward offering a fifth bar of soap may be retrieved for a customer purchasing four bars of soap. The steps performed in determining particular rewards for customers is consistent with currently available, adopted, and practiced user affinity determination processes and customer relationship management (CRM) techniques. Processing then terminates at block 640.

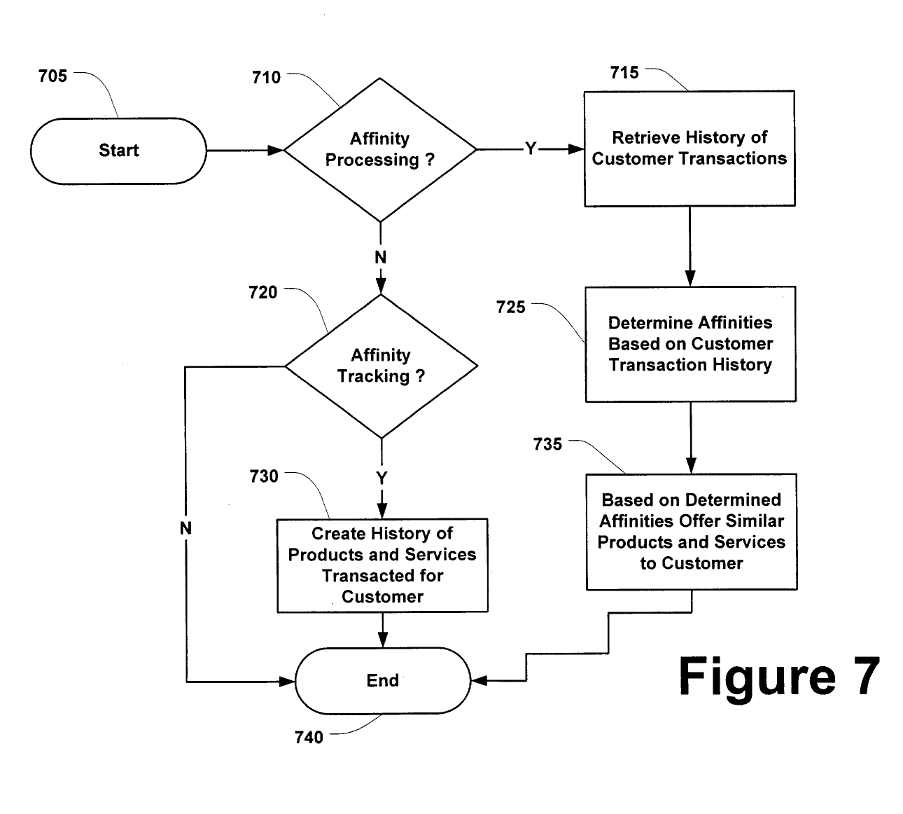

FIG. 7 shows the processing performed by the herein described systems and methods in determining customer affinities. As shown, processing begins at block 705 and proceeds to block 710 where a check is performed to determine if customer affinities are to be processed. If user affinities are not to be processed, processing proceeds to block 720 where a check is performed to determine if customer affinities are to be tracked. If customer affinities are not to be tracked, processing terminates at block 740. However, if at block 720, it is determined that user affinities are to be tracked, processing proceeds to block 730 where a history of products and services transacted by the customer is created and stored.

However, if at block 710, it is determined that affinity processing is to be performed, processing proceeds to block 715 where the history of customer transactions is retrieved. From there, processing proceeds to block 725 where affinities are determined based on the customer transaction history. The herein described systems and methods contemplate the use of currently available, adopted, and deployed affinity algorithms for use in determining affinities between various data such as customer transaction data. Processing then proceeds to block 735 where based on the determined affinities determined at block 725, similar products and/or services to those previously transacted by the customer are offered to the customer. From there, processing then terminates at block 740.

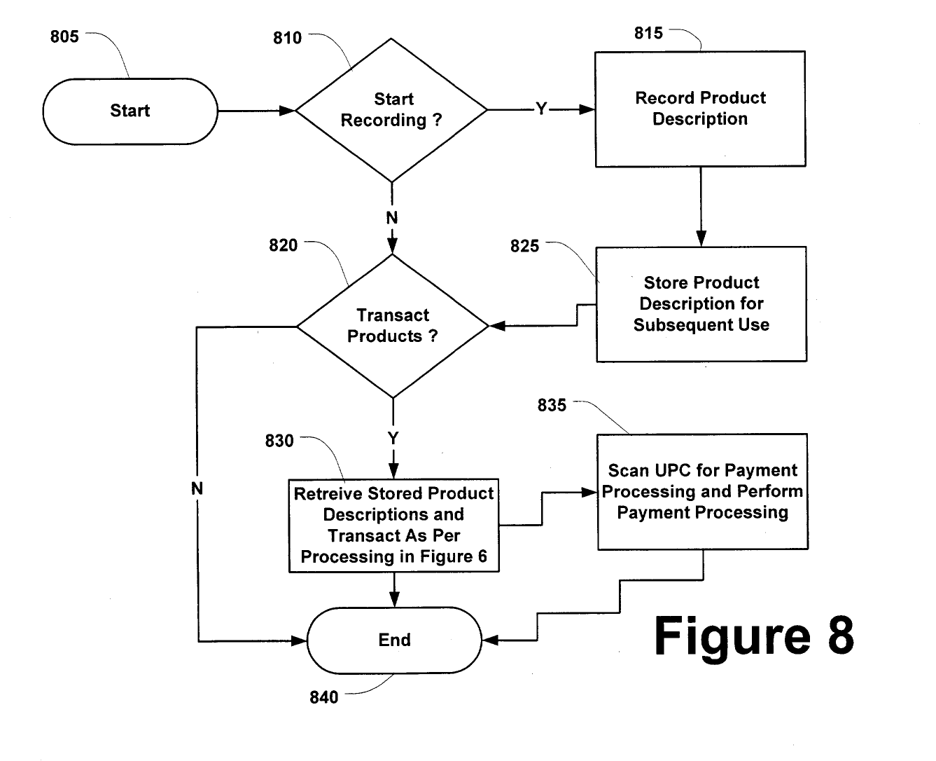

FIG. 8 shows the processing performed when storing product information for us in subsequent customer transactions. As shown, processing begins at block 805 and proceeds to block 810 where a check is performed to determine if recording should be initiated. If recording is not be initiated, processing proceeds to block 820 where a check is performed to determine if products/services are to be transacted. If check at block 820 indicates that there are no products for transaction, processing then terminates at block 740. However, if there are products/services to be transacted, processing proceeds to block 830 where the stored product/service descriptions are retrieved and the products/services transacted as per the processing described in FIG. 6.

If however, at block 810 recording is to be initiated, processing proceeds to block 815 where product/service descriptions are recorded. As described above, the herein described systems and methods contemplate the use of a portable electronic device in cooperation with electronic/product service labels describing various products/services that, in operation, communicate with each other to record descriptions about various products/services. Processing then proceeds to block 820 and proceeds there from.

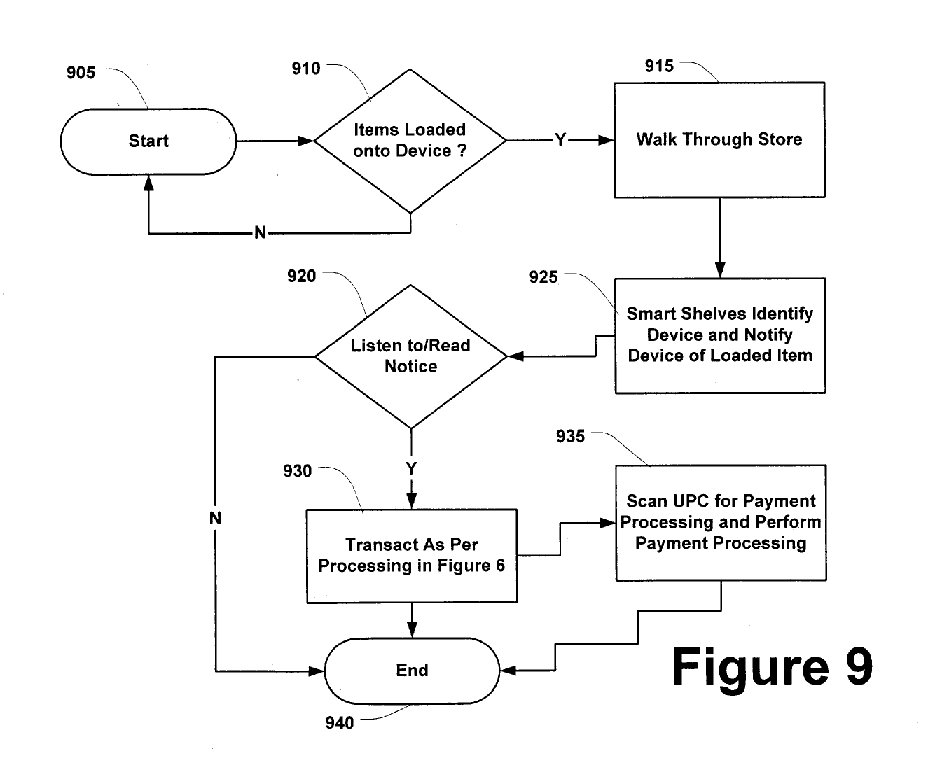

FIG. 9 shows the processing performed by unified electronic transaction fulfillment system 300 when encountering smart shelves at a point of sale. A smart shelve is store shelf having some intelligence to communicate with various electronic media information about a product/service found on the shelf. This may be realized through the use of a number of wireless communication protocols (as described above in the context of the electronic media). As shown, processing begins at block 905 and proceeds to block 910 where a check is performed to determine if product/service information was loaded onto the electronic device. If there is no product/service information, processing reverts back to block 500. If, however, product/service information has been loaded processing proceeds to block 915 where the consumer walks through the store. From there processing proceeds to block 925 where the smart shelves identify that the consumer is carrying electronic transaction media. The smart shelf identifies the consumer that there is a desired product/service on the shelf they have just passed or standing near. A check is then made to determine if the consumer is to read/listen to the notice. If the consumer ignores the smart shelf notice, processing proceeds to block 940 and terminates. If, however, the consumer listens to the smart shelf notice and decides to purchase the product/service, processing proceeds to block 930 where the product/service is transacted as per the processing described in FIG. 6. The electronic media is then processed for payment processing and payment processing realized at block 935. Processing then terminates at block 940.

The herein described systems and methods provide a unified electronic transaction fulfillment system supporting various applications and features including electronic payment solutions that exploit legacy transaction systems, consumer affinity determination, consumer tracking, targeted marketing, and subsequent transaction fulfillment. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A system providing unified transaction fulfillment comprising:
a portable media capable of storing and/or displaying at least one unique UPC bar code; and
a computing application capable of deciphering the one unique UPC bar code from the media and processing said UPC bar code to determine affinities relating to product and/or service purchases and for use in payment processes.

2. The system as recited in claim 1, further comprising a scanning device, said scanning device for use to decipher the one unique UPC bar code.

3. The system as recited in claim 2, further comprising a data store, the data store cooperating with the computing application to store information indicative of customer information.

4. The system as recited in claim 3, wherein the customer information comprises any of: demographic information, payment information, transaction histories for customers, and customer affinity information.

5. The system as recited in claim 4, wherein the computing application determines affinities relating to product and/or services purchases using the customer information.

6. The system as recited in claim 4, wherein computing application resides on a computer server in communication with said scanner via a communications network.

7. The system as recited in claim 5, wherein the communications network comprises any of: a fixed wire LAN, a wireless LAN, a fixed wire WAN, a wireless WAN, a fixed wire peer-to-peer network, a wireless pee-to-peer network, the Internet, and the wireless Internet.

8. The system as recited in claim 1, wherein said media comprises any of FOB wand, RKE device, wristwatch, print media, a SIM card, a lighter, on currency in the form of machine readable ink, eyeware, jewelry, mobile device housing and/or clip, and mobile electronic device.

9. The system as recited in claim 8, wherein said mobile electronic device comprises any of a mobile telephone, a mobile pager, and a mobile PDA.

10. The system as recited in claim 9, wherein said mobile electronic device are capable of supporting wireless protocols comprising any of: BlueTooth, WiFi, Ultra Wideband, and RFId.

11. The system as recited in claim 1, wherein the one unique UPC bar code has varying shapes, sizes, orientations, components, and configurations.

12. The system as recited in claim 11, wherein the unique UPC bar code comprises a non-traditional bar code comprising any of: a slanted line bar code, a squiggly line bar code, a bar code made of uniform circles, and a bar code made of uniform squares.

13. The system as recited in claim 12, wherein the computing application only upon processing the non-traditional bard code initiates payment processes.

14. The system as recited in claim 1, wherein the one unique UPC bar code comprises a customer's UPC bar code found on the customer's materials comprising any of: a drivers license, a passport, a health card, a gym membership card, a water meter, and a gas meter.

15. A method for unified transaction fulfillment comprising the steps of:
providing a consumer with a unique UPC bar code, said unique UPC bar code being associated with consumer information comprising any of: consumer bank/credit card accounts, consumer product/service preferences, and consumer affinities;
providing retailers with a computing application operating in a computing environment, wherein said computing application is capable of receiving said unique UPC bar code and processing said unique UPC bar code to realize two or more of the following operations: product/service payment, consumer tracking, targeted marketing, and consumer affinity determinations.

16. The method as recited in claim 17, wherein said operations realized comprise any of: real-time operations realization and non-real-time operations realization.

17. The method as recited in claim 15, further comprising storing transaction histories for customers, the customer transaction histories used to determine the customer affinities.

18. The method as recited in claim 15, further comprising communicating the unique bar code from the retailers to a transaction service provider, the transaction service provider storing the consumer information.

19. A system providing unified transaction fulfillment comprising:
a media capable of storing and/or displaying data indicative of a desired product and/or service; and
a computing application capable of receiving said data from said media and processing said data as part of a subsequent transaction fulfillment.

20. The system as recited in claim 19 wherein the media cooperates with electronic labels and/or smart shelves at points of sale to obtain the desired product and/or service data.

21. The system as recited in claim 20 wherein the desired product and/or service data is communicated from the electronic labels and/or smart shelves to the media using low power wireless communications.

22. The system as recited in claim 19, wherein the computing application resides on a networked computing environment comprising at least one client computing device and a computer server.

23. The system as recited in claim 22, wherein the computing application receives the desired product and/or service data from the media by cooperating with the media via the client computing device and processing the received data on the computer server.

24. At a point of sale a method to realize transaction fulfillment comprising the steps of:
responsive to the purchase of a product and/or service, receiving a unique UPC bar code at the point of sale, the unique UPC bar code having associated with it payment and affinity information for a customer; and
retrieving the associated customer information using the unique UPC bar code from a data store operating in a computing environment, the computing environment executing a computing application capable of performing transaction fulfillment and affinity determination.

25. The method as recited in claim 24 further comprising reconciling payment for purchased products and/or services.

26. The method as recited in claim 25 further comprising processing the customer information to obtain payment information for payment reconciliation.

27. An apparatus to realize transaction fulfillment comprising:
a media capable of storing and/or displaying a unique UPC bar code, the UPC bar code having information indicative of customer information including customer payment information, customer affinity information, customer coupon preferences; and
a communication component, the communication component capable of communicating the unique UPC bar code to a cooperating computing environment for use in payment processes and in affinity determination processes.

28. The apparatus recited in claim 27 further comprising a electronic storage component for use in storing data representative of desired products and/or services.

29. The apparatus recited in claim 28 wherein the communication component is capable of communicating with electronic labels.

30. The apparatus recited in claim 28 wherein the cooperating computing environment processes the unique UPC bar code to retrieve the customer information, the customer information residing on a cooperating data store.

31. The apparatus recited in claim 28, wherein the coupon is redeemed at a point of sale through a coupon transaction process, such that desired coupons are stored on the electronic media and are redeemed as in conjunction with payment processing when performing transaction fulfillment.

32. A system providing unified transaction fulfillment comprising:
a means for storing and/or displaying data indicative of a desired product and/or service; and
a means for receiving said data from said media and processing said data as part of a subsequent transaction fulfillment.

33. The system as recited in claim 32 wherein the means for storing cooperates with electronic labels and/or smart shelves at points of sale to obtain the desired product and/or service data.

34. The system as recited in claim 32 wherein the desired product and/or service data is communicated from the electronic labels and/or smart shelves to the media using low power wireless communications.

35. The system as recited in claim 32, wherein the means for receiving resides on a networked computing environment comprising at least one client computing device and a computer server.

36. The system as recited in claim 35, wherein the computing application receives the desired product and/or service data from the media by cooperating with the media via the client computing device and processing the received data on the computer server.

37. An apparatus to realize transaction fulfillment comprising:
a means for storing data, the means for storing capable of storing and/or displaying a unique UPC bar code, the UPC bar code having information indicative of customer information including customer payment information, customer affinity information, customer coupon preferences; and
a communication means, the communication means capable of communicating the unique UPC bar code to a cooperating computing environment for use in payment processes and in affinity determination processes.
